(19) United States
(12) Patent Application Publication
(10) Pub. No.: US 2010/0314427 A1
(43) Pub. Date: Dec. 16, 2010

(54) Fishing Accessory

(76) Inventor: Mark A. Cartwright, Baton Rouge, LA (US)

Correspondence Address: R. Bennett;Ford, 2355 Drusilla Lane, Baton Rouge, LA, 70809, US

(21) Appl. No.: 12/485,152

(22) Filed: Jun. 16, 2009

(51) Int. Cl. A01K 97/00; A01K 97/18; A41D 19/00; A45F 5/00

(52) U.S. Cl. 224/576; 43/53.5; 2/161.5; 224/162; 224/191

(57) ABSTRACT

An improved fishing accessory for use in fishing operations. The fishing accessory comprises a housing configured to be affixed to a user's hip or waist via an item of clothing. The housing may further include a retractable fish gripping-glove and a tool such as a fish hook-extraction member.

### BACKGROUND OF THE INVENTION

1. Field of the Invention

This invention relates to the sport of fishing in general and to an improved fishing accessory for use in fishing applications, in particular.

2. Prior Art

Recreational fishing is one of the most popular and steadily growing industries in the United States. As the industry has grown, the demand for cost-efficient, high-quality fishing tools and articles, such as handling gloves, lures, hooks, bait, hook-extraction member, etc. has skyrocketed as well. Anglers often utilize different types of such tools in fishing operations. However, several problems exist in the prior art, with regard to such tools and articles. For example, during the fishing application, it is generally cumbersome to keep the various articles sufficiently organized and positioned such that they are readily accessible when needed. As a result, time is often wasted in searching for the desired article, and in many cases, the fish may be lost or unnecessarily injured as a result of delay during this critical period. Furthermore, once the use of a particular tool has been completed, it is often time-consuming to account for and store the individual tools and articles in their respective locations. As a result, such articles are frequently lost. The aforementioned problems increase the time and cost considerations associated with fishing operations, while decreasing efficiency.

Accordingly, an improvement over what is available in the prior art is desired. For these reasons, an improved fishing accessory meeting the following objectives would be highly desirable.

### OBJECTS OF THE INVENTION

It is an object of the invention to provide a single and improved fishing accessory that is capable of housing a plurality of fishing tools.

It is another object of the invention to provide an improved fishing accessory that allows for the organization and positioning of a plurality of fishing tools, such that these articles are easily accessible to the angler during fishing operations.

It is another object of the invention to provide for an improved fishing accessory that allows an angler to access the various fishing tools using only one hand.

Yet another object of the invention is to provide an improved fishing accessory that reduces the chances of tool loss.

It is another object of the invention to decrease the time and cost considerations associated with fishing operations.

It is another object of the invention to provide an improved fishing accessory that is reliable, efficient, and easy to use.

Yet another object of the invention is to provide an improved fishing accessory that is simple in construction and capable of being manufactured at a reduced cost.

These and other objects of the invention shall become apparent from the ensuing figures and descriptions of the invention.

### SUMMARY OF THE INVENTION

An improved fishing accessory is disclosed. The preferred embodiment generally comprises a housing configured to be affixed to an angler's side or waist via an item of clothing worn by the angler. The housing is preferably provided with a retractable fish-gripping glove and an extraction member for fishhook extraction.

### BRIEF DESCRIPTION OF THE FIGURES

FIG. 1 depicts an exploded view of a preferred embodiment of the fishing accessory of the present invention and its various components, including a fish-gripping glove, hook-extraction member, and spring-loaded reel.

FIG. 2 is a front view of a preferred embodiment of the assembled fishing accessory.

FIG. 2A is a front view of a preferred embodiment of the assembled fishing accessory showing the glove hanging from a glove retaining member.

FIG. 3 is a back view of a preferred embodiment of the assembled fishing accessory.

FIG. 4 is a perspective view of a preferred embodiment of the fishing accessory, depicting an end of the housing comprising a sheath and an angled opening. The arrows depict the capability to insert the pliers either directly into the sheath, or indirectly, via the angled opening.

FIG. 5 is a front view of a preferred embodiment of the fishing accessory, with the arrows depicting the extension and retraction capability of the fish-gripping glove, the arrows further showing the rotational capability of the spring-loaded reel.

FIG. 6A depicts an angler donning a preferred embodiment of the fishing accessory.

FIG. 6B depicts the angler utilizing the fish-gripping glove to grasp a fish.

FIG. 6C depicts the angler utilizing the hook-extraction member to extract the hook from the fish's mouth.

### DETAILED DESCRIPTION OF THE INVENTION

An improved fishing accessory 1 is disclosed. Without any intent to limit the scope of this invention, reference is made to the Figures in describing the preferred embodiments of the invention.

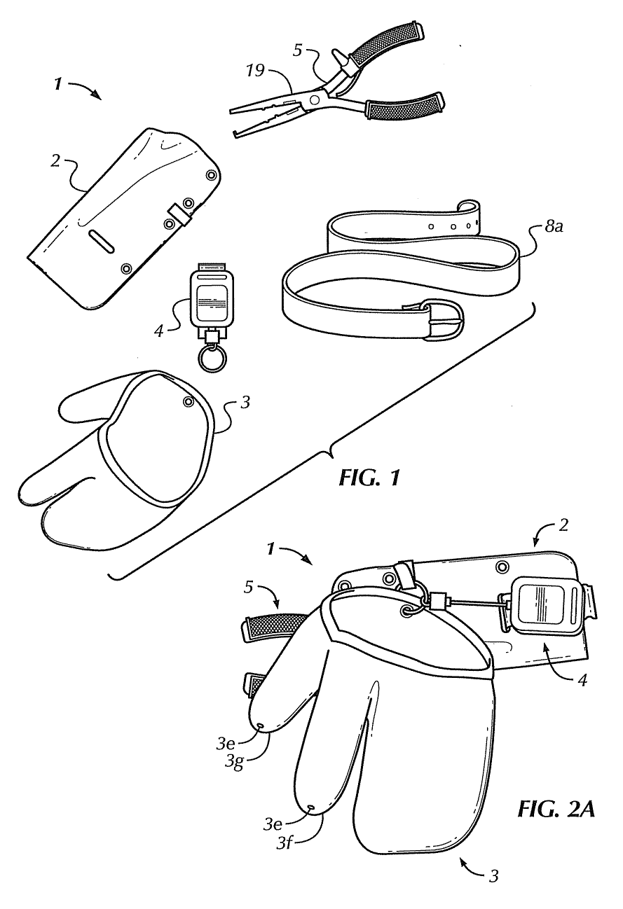

Fishing accessory 1 of the invention is relatively simple, yet durable, in construction. Fishing accessory 1 is designed to be utilized in a plethora of fishing applications, as will be discussed below. As depicted by FIGS. 1-3, in a preferred embodiment, fishing accessory 1 comprises a housing 2 of any desirable length and width. In constructing housing 2, the inventor contemplates using a hard resilient plastic, such as Kydex™. However, it is anticipated that various other suitable materials, could also be acceptable to construct housing 2, according to the anticipated conditions of use.

As further depicted by FIG. 3, housing 2 comprises an attachment member 7 to secure housing 2 to an article of clothing 8 worn by the user, such as a belt or pants 8a. If clothing article is belt 8, then belt 8 should preferably be capable of being adjusted to allow for varying waist sizes. In this embodiment, attachment member 7 preferably comprises a loop 7 to attach housing 2 of fishing accessory 1 to belt 8. However, it is contemplated that other suitable attachment members, such as snaps, hooks, buttons, clips, etc. would also be suitable to attach housing 2 to article of clothing 8. As further depicted by FIGS. 1-3, housing 2 comprises a first end 2a and a second end 2b. In a preferred embodiment, a fish-gripping glove 3 is secured to first end 2a of housing 2. It is preferred that fish-gripping glove 3 be retractably secured to housing 2 through a suitable mechanism, such as, for example, a spring-loaded reel 4, comprising a retractable line 4a. See FIG. 5. Spring-loaded reel 4 could be rigidly fixed to housing 2. However, in a preferred embodiment, spring-loaded reel 4 is rotatably mounted to first end 2a of housing 2, with fish-gripping glove 3 in turn being detachably affixed to spring-loaded reel 4 via attachment means 4b such as rings, hooks, loops, snaps, etc. Spring-loaded reel 4, retractable line 4a, and attachment means 4b will preferably all be constructed of corrosion resistant materials suitable for use in wet conditions and most preferably of materials suitable for use in saltwater environments.

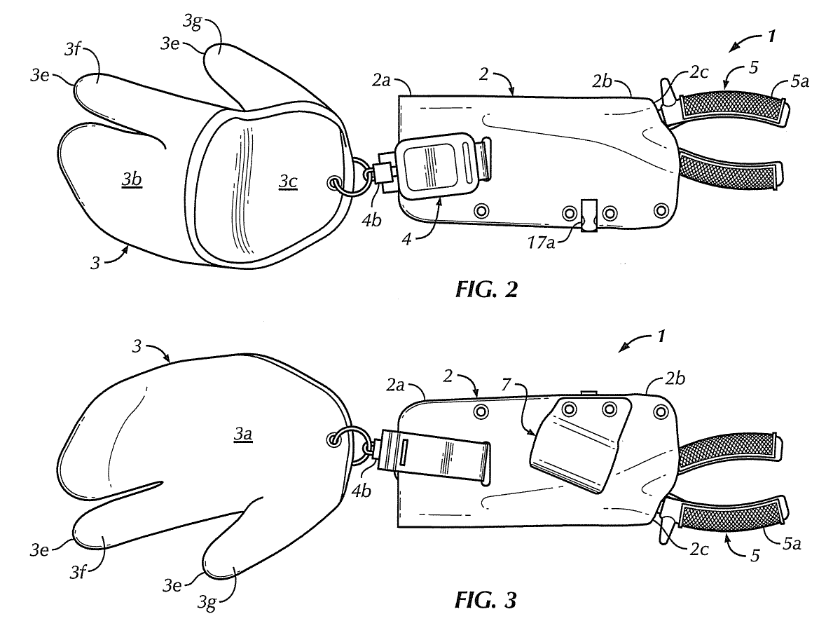

Continuing with a discussion of a preferred embodiment of fishing accessory 1, a glove-retaining member 17, such as a hook or peg 17a, may be mounted to housing 2 to retain glove 3. See FIG. 2. This is particularly useful in high speed travel operations, wherein the winds generated can cause glove 3 to pull line 4a out of reel 4, such that line 4a may become tangled and glove 3 is no longer within close reach.

In a preferred embodiment, accessory 1 will further house another fishing item or tool 19, beside glove 3. See FIGS. 1-2. As an example, this tool could comprise a fish hook-extraction device 5. Hook-extraction device 5 preferably comprises a pair of stainless steel needle nose pliers 5a. Tool 19 could comprise other accessories such as crimpers, cutters, knives, scissors, hook sharpeners, screwdrivers, etc., depending on what is desired. Alternatively, these features could be incorporated into hook-extraction device 5.

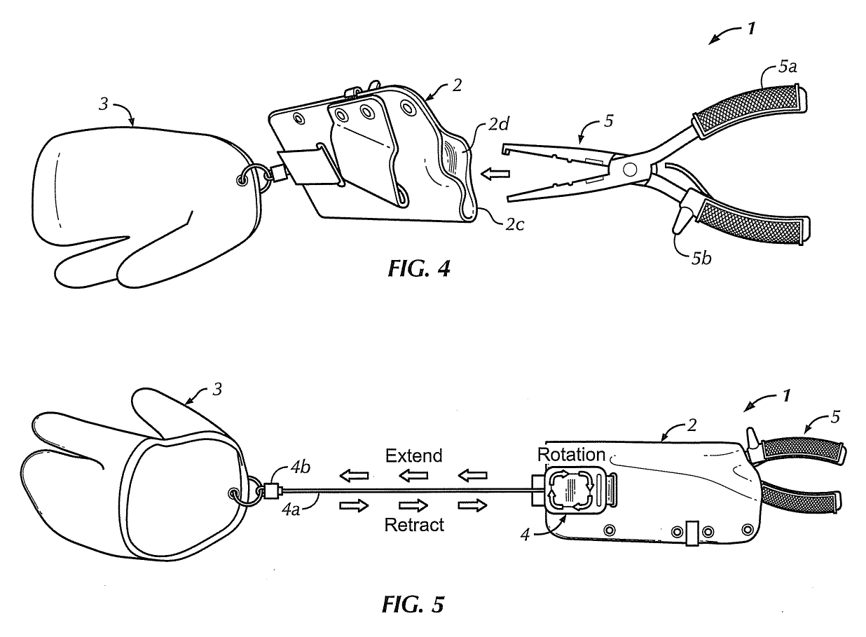

In a preferred embodiment, pliers 5a will further comprise a shoulder 5b and second end 2b of housing 2 will comprise a sheath 2c designed to grip pliers 5a. Second end 2b of housing 2 will further comprise an angled aperture 2d leading into sheath 2c. See FIG. 4. This particular configuration of pliers 5a and housing 2, will give the angler the flexibility to insert pliers 5a into sheath 2c directly, or indirectly via the angled aperture 2d. This, in conjunction with the hardness of housing 2, will achieve a snug and releasable locking fit of pliers 5 a within housing 2.

As discussed above, fishing accessory 1 includes a fish-gripping glove 3. As fish generally tend to be slippery, fish-gripping glove 3 is useful because it will provide a secure griping surface to allow the angler to achieve a firm grip, while keeping his hands clean.

In one preferred embodiment, fish-gripping glove 3 has two components. The inner component is preferably constructed from waterproof, tear-resistant material, such as knitted Spectra® or Kevlar®. Other materials might include nylon or, less preferably, cotton. The second component is formed by coating the inner component with a protective layer of rubber or plastic. One preferred coating is liquid latex, which will be pliable after setting. Whatever coating is used will preferably have a no-slip finish.

However, fish-gripping glove 3 may be constructed from a variety of different materials, depending on the particular fishing application. For example, it may be desirable to construct fish-gripping glove 3 from metal mesh in those fishing applications involving big game, such as tarpon or billfish, where protecting the angler's hand is a priority. Similar glove construction may be appropriate when glove 3 is expected to be used extensively in fish cleaning. In these applications, metal, wire, plastic or fiber mesh may be used to construct glove 3. Commercially available examples of such mesh gloves 3 include the Aftco Bluefever® Glove and the Whizard® Metal Mesh Glove. In other fishing applications, such as those involving the catch and release of trout, it may be desirable to construct glove 3 from neoprene rubber, to reduce the chances of harming the fish as well as to reduce the possibility of passing bacteria from the angler's hands to the fish. Commercially available examples of such neoprene gloves 3 include the Seavenger® Neoprene Water Fishing Glove and the Fish USA® Field and Stream Neoprene Fishing Glove. It is to be understood that the above mentioned materials are illustrative only, and that a variety of other suitable materials may also be utilized to construct glove 3, depending on the particular fishing application.

As discussed above, fish-gripping glove 3 will preferably be detachably affixed to spring-loaded reel 4 via such attachment means 4b as rings, hooks, loops, snaps, etc. This is advantageous because it will allow the angler to selectively attach to his belt 8a whatever fish-gripping glove 3 he deems to be most appropriate for a particular fishing application.

Continuing with a discussion of the construction of fish-gripping glove 3, glove 3 is preferably one-size-fits-all; however, it may be constructed to be any size suitable for the angler. Furthermore, glove 3 can be designed for either a right handed or left handed angler. As depicted by FIGS. 1 and 2, in a preferred embodiment, glove 3 will comprise a palm side 3a and a back side 3b. To promote a one-handed operation, back side 3b will preferably be substantially open, thereby creating an oversized mouth 3c, to allow for a quick and easy insertion of the angler's hand into glove 3. Mouth 3c may be flared to allow the angler to more easily insert his hand into mouth 3c. The perimeter of mouth 3c will form a border where the coating meets the fabric portion in one preferred embodiment of fish gripping glove 3. A hem may be provided to secure these components together. A wire, preferably of aluminum or stainless steel, may be included in the hem in order to maintain the shape of mouth 3c.

In a further preferred embodiment, glove 3 will comprise an index finger section 3f, and a thumb section 3g and apertures 3e will be provided in both sections 3f and 3g, to allow any water that might enter glove 3 to drain.

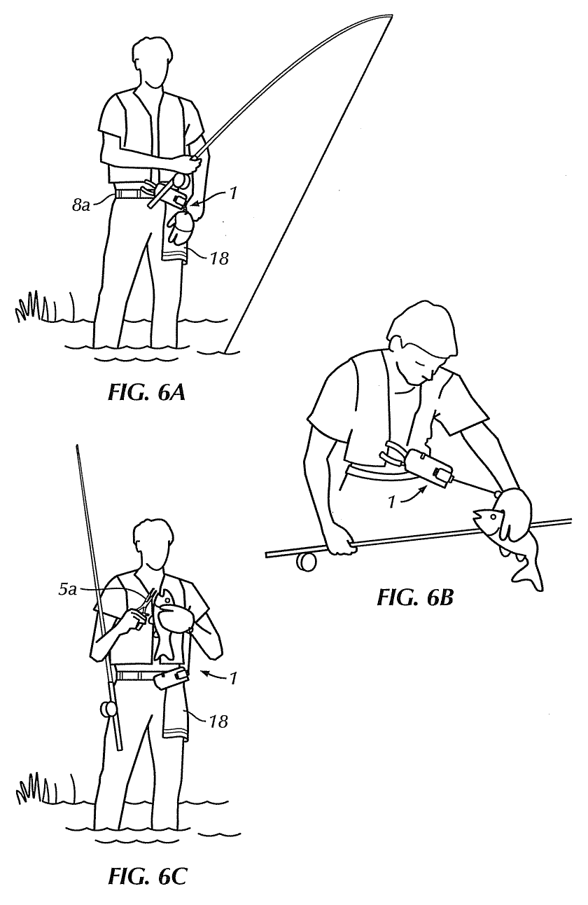

In application, as depicted by FIGS. 6A-6C, the preferred embodiment of fishing accessory 1, when assembled, will include a fish-gripping glove 3 and fish hook-extraction pliers 5a releasably locked within sheath 2c of housing 2. In use, the angler will first don an article of clothing 8, such as an adjustable waist belt 8a. The angler will then attach assembled fishing accessory 1 of the present invention to belt 8a via belt-attachment loop 7, situated on housing 2 of fishing accessory 1. The angler may then adjust waist belt 8a to ensure that fishing accessory 1 and its tools are at a conveniently accessible position at his waist or hip. If the fishing operation involves high speed travel, the angler may desire to retain glove 3 on hook or peg 17a to ensure that glove 3 does not cause line 4a to be pulled out of reel 4. See FIG. 6A. Thereupon, the angler may engage in any tasks necessary to the fishing application, such as baiting the hook, casting, etc. When the angler is ready to grasp the fish, all the angler needs to do is quickly and easily slip his hand into glove 3 via mouth 3c and lift glove 3 from hook or peg, if applicable. See FIG. 6B. As discussed above, in a preferred embodiment, glove 3 is rotatably and retractably mounted to housing 2 of fishing accessory 1. This flexible configuration gives the angler the freedom to extend and retract his hand in any direction, while keeping glove 3 securely affixed to housing 2. Furthermore, spring loaded reel 4 will keep glove 3 on the angler's hand. If the angler moves his hand into a downward oriented position from which glove 3 might otherwise easily slip off, reel 4 will apply tension to glove 3 via line 4a, keeping glove 3 in place. After the angler has achieved a firm grasp on his game, he may then retrieve hook-extraction pliers 5a from their position within sheath 2c of housing 2 by simply pulling them out and utilizing same to extract the hook from the mouth of the fish. See FIG. 6C. If hook-extraction pliers 5a comprise the additional features discussed above, then hook-extraction pliers 5a may also be utilized for any other desired function. Thus, in this manner, the angler is able to easily access and deploy both glove 3 and hook-extraction pliers 5a, and neither time nor efficiency is lost. After the fishing application has been completed, the angler may then quickly return the components of fishing accessory 1 to the ready position by inserting fish hook-extraction pliers 5a back into sheath 2c and returning his gloved hand to his side immediately adjacent housing 2 and then simply taking his hand out of glove 3. Alternatively, the angler could pull glove 3 off of his hand at any location and reel 4 will retract line 4a, pulling glove 3 back to housing 2. If desired, glove 3 may be manually placed back on hook or peg 17a. As fishing accessory 1 is compact, it can be easily stored in the desired location, such as a tackle box or a tool box, and then retrieved for future re-use.

Fishing accessory 1 is also particularly suited for fish cleaning. The user will slip his hand into glove 3 via mouth 3c as described above and use glove 3 to grip the fish. Glove 3 will allow the user to hold the fish more securely, and it may also serve to protect the user's hand during cleaning. Housing 2 may be provided with tool 19 in the form of a knife in place of or in addition to hook-extraction device 5 in order to facilitate fish cleaning. When a knife is included as part of accessory 1, it will preferably be contained in a sheath in substantially the same fashion as sheath 2c and pliers 5a.

In an additional preferred embodiment, fishing accessory 1 may be provided with a towel 18. Towel 18 could depend from housing 2. However, in the most preferred configuration towel 18 will preferably be positioned behind housing 2—that is, between the angler and housing 2. Preferably, towel 18 is operatively secured to attachment member 7 of housing 2 so that towel 18 will be aligned with housing 2 relative to the angler's body. When housing 2 is secured to belt 8, towel 18 will preferably be tapered at one end to allow it to fold over the upper edge of belt 8 and tuck into the angler's pants. This will allow towel 18 to cover the complete area behind fishing accessory 1 and the angler's pants. This will protect the angler's pants from water and other material carried on glove 3 or pliers 5a. Likewise, it will provide a convenient place for the angler to dry his hands after handling a fish, applying sunscreen, and etc. In summary, fishing accessory 1 is simple in construction, easy to use, and can be utilized in a plethora of fishing applications. In addition, fishing accessory 1 allows for the organization and positioning of a plurality of fishing tools, to make such articles easily accessible to the angler during fishing applications.

It should be noted that although accessory 1 of the present invention has been discussed in the context of fishing applications, there are many instances in which conditions change quickly from those in which the protection of a glove is needed to those in which the full dexterity and tactile sensitivity of a glove-free hand are required Thus, accessory 1 may be useful outside of fishing applications. In such scenarios, the basic concept of accessory 1 would remain the same; however, the specifics could be modified to fit a particular application. As a non-limiting example, accessory 1 would be quite useful in a kitchen or outdoor cooking application whereby easy access to an oven mitt 3 is desired. In this embodiment, accessory 1 would be securable to the user's belt or other article of clothing, and mitt 3 would be rotatably and retractably mounted to housing 2 of accessory 1, to provide for a free range of hand motion for the user, while keeping mitt 3 securely attached. In this application, mitt 3 may have a partially open-back construction, if desired, and may further be designed to be heat-resistant. Further, housing 2 of accessory may comprise pegs, hooks, or the like to retain other kitchen tools and utensils, such as knives, spoons, etc. Such kitchen tools and utensils could also be retained within sheath 2c of housing 2, in the manner discussed above.

While the invention has been described in terms of its preferred embodiment, embodiments will be apparent to those of skill in the art from a review of the foregoing. Those embodiments as well as the preferred embodiments are intended to be encompassed by the scope and spirit of the following claims.

I claim:

1. An improved fishing accessory comprising:
a. a housing configured to be affixed to a user's article of clothing;
b. a fish gripping glove retractably secured to the housing.

2. The improved fishing accessory according to claim 1, further comprising a fish hook-extraction device secured to the housing.

3. The improved fishing accessory according to claim 2, wherein the hook-extraction device comprises a pair of pliers.

4. The improved fishing accessory according to claim 2, wherein the housing comprises a sheath configured to snugly and releasably receive the fish hook-extraction device, and an angled opening leading into the sheath.

5. The improved fishing accessory according to claim 1, wherein the housing includes an attachment loop for connection to a belt.

6. The improved fishing accessory according to claim 1, wherein the fish gripping glove comprises a palm side and a back side, wherein the back side is substantially open.

7. The improved fishing accessory according to claim 1, wherein the fish gripping glove is retractably secured to the housing via a spring loaded reel.

8. The improved fishing accessory according to claim 7, wherein the spring loaded reel is rotatably secured to the housing.

9. The improved fishing accessory according to claim 8, wherein the fish gripping glove is detachably secured to the spring loaded reel.

10. The improved fishing accessory according to claim 1, wherein the fish gripping glove is comprised of neoprene rubber.

11. The improved fishing accessory according to claim 1, wherein the fish gripping glove is comprised of plastic.

12. The improved fishing accessory according to claim 11, wherein the housing is comprised of kydex.

13. The improved fishing accessory according to claim 1, wherein the fish gripping glove is comprised of rubber.

14. The improved fishing accessory according to claim 13, wherein the housing is comprised of kydex.

15. The improved fishing accessory according to claim 1, wherein the fish gripping glove is comprised of metal.

16. The improved fishing accessory according to claim 1, wherein the housing further comprises a glove-retaining member.

17. The improved fishing accessory according to claim 1, wherein the glove comprises a finger section and a thumb section, and wherein each section comprises an aperture.

18. The improved fishing accessory according to claim 1, wherein the housing further comprises a towel.
